(19) United States
(12) Patent Application Publication
(10) Pub. No.: US 2008/0163770 A1
(43) Pub. Date: Jul. 10, 2008

(54) IMAGE PRINTING APPARATUS FOR SMALL AREAS

(76) Inventors: Bien Trong Bui, Howell, MI (US); Erio F.J.M. Van Der Meulen, Wixom, MI (US)

Correspondence Address: EXATEC;C/O BRINKS HOFER GILSON & LIONE, P. O. BOX 10395, CHICAGO, IL, 60610, US

(21) Appl. No.: 11/965,159

(22) Filed: Dec. 27, 2007

Related U.S. Application Data
(60) Provisional application No. 60/882,302, filed on Dec. 28, 2006.

(51) Int. Cl. B05C 17/06; B41M 1/12

(52) U.S. Cl. 101/123; 101/129

(57) ABSTRACT

An apparatus for printing designs or images on a small or constrained area of a substrate. The apparatus includes a screen assembly, a print head, and a guide assembly. A squeegee and a flood bar of the print head are positioned at a predetermined angles and an actuator facilitates switching positions of the flood bar and squeegee through actuation of a toggle mechanism during the print cycle.

### CROSS REFERENCE TO RELATED APPLICATIONS

This application claims priority to U.S. provisional application Ser. No. 60/882,302 filed Dec. 28, 2006.

### BACKGROUND OF THE INVENTION

The present invention generally relates to screen printing. More particularly, the invention relates to a printing apparatus, which is small in size for printing images on small areas of objects that may have a surface characterized as flat, curved, or constrained by the presence of a frame, lip, rib, or some other feature that exhibits a change in step height.

Screen printing is a conventional printing technique known for applying an image to relatively flat surfaces. The compatibility of the inks used in screen printing has been well established for a variety of substrates, such as textiles, ceramics, metal, wood, paper, glass, composites, and plastic. As a result, screen printing is used in many different industries, ranging from clothing to circuit board printing.

Conventional screen printing devices usually employ a print mechanism in which the print cycle includes an initial vertical downward movement of the flood bar, then a horizontal movement of the print head during a flood stroke followed by an upward movement of the flood bar and a downward movement of the squeegee. The subsequent print stroke is another horizontal movement, followed by an upward squeegee movement at the end of the cycle. These simple steps require a number of actuators, typically air cylinders for the vertical movements and a timing belt for the horizontal strokes, which limit the minimum size of the printing equipment. The large size of the equipment leads to difficulty in printing images with great clarity on small substrates, as well as on substrates whose surface is curved or constrained by a feature exhibiting a change in step height. Accordingly, it would be advantageous to have a printing apparatus with reduced size and a simplified mechanism that is adaptable to print images with great clarity on small curved or constrained surfaces.

### BRIEF SUMMARY OF THE INVENTION

In overcoming the drawbacks and limitations of conventional screen printing, an image printing apparatus is disclosed. Accordingly, in one aspect, the present invention provides an image printing apparatus for printing images on small areas.

The printing apparatus generally includes a screen assembly with a printing screen and a flexible screen frame mounted onto a frame holder. The screen frame may be made of flat spring steel, which will allow it to be shaped according to the curvature of the substrate.

Another component of the printing apparatus is a squeegee assembly that is a combined holder for both a squeegee and flood bar, which are positioned at a predetermined angle and supported by a movable print head. The print head is positioned vertically above both the squeegee and the flood bar and is movable in a horizontal direction parallel to the screen for printing. In the present invention, the printing apparatus has no means to support the substrate. The substrate is held stationary by a separate fixture.

In one embodiment of the present invention, the print mechanism of the image printing apparatus is controlled by a guide assembly comprising at least one guide rod and at least one pneumatic actuator or air cylinder. The squeegee assembly is connected to the air cylinder by a pivoting means used for varying the angle of the squeegee assembly relative to the surface of the substrate. During the print cycle, the reciprocating movement of the guide assembly along the guide rod toggles the pivoting motion of the squeegee and the flood bar. This pivoting motion is actuated by an air cylinder. The design of the squeegee assembly, the pivot point, and the actuator location is in such a way that the toggling results in a downward movement of the squeegee and the flood bar thereby applying pressure onto the screen frame.

In another embodiment of the present invention, the guide assembly is mounted on a print guide track flanked on both sides by guide belts. A push rod, mounted on the side wall of the printing apparatus, actuates a pivot mechanism that allows the squeegee assembly to present either the flood bar or the squeegee as the print head moves back and forth along the print direction during the print cycle, thereby pressing the ink through the screen with sufficient pressure to apply a printed image to the substrate.

In yet another embodiment of the present invention, a printing apparatus is provided that is small in size. The reduced size of the printing apparatus has a two-fold advantage over conventional screen printing. First, the printing apparatus has the ability to print images on small areas of substrates. Examples of such images include logos, trademarks, pictures, and fractal antennas. Second, the printing apparatus can be moved by a transporting means, more particularly, by a robot, to a stationary or fixed substrate, such as an automotive plastic window. In an adaptation to this embodiment, the fixed substrate may be moved along by a conveyor belt, while the robot in its “line tracking” mode keeps the printing apparatus in a constant position relative to the fixed substrate. Alternatively, the printing apparatus can be made stationary with the substrate being moved by the robot.

A further aspect of the present invention is to provide an image printing apparatus that is capable of printing close to a change in step height or surface transitions formed in an object by the presence of design features, such as a frame, lip, or rib.

### BRIEF DESCRIPTION OF THE DRAWINGS

The present invention will be better understood from the detailed description given herein below in conjunction with the accompanying drawings, which are given by way of illustration only and are not intended to limit the scope of the present invention, wherein:

FIG. 1 is an illustration of the printing apparatus, embodying the principles of the present invention, attached to a robot that is in the process of applying an image onto the surface of a substrate;

FIG. 2 is a cross-sectional diagrammatic view of the printing apparatus including the print head with squeegee and flood bar assemblies;

FIG. 3 is a cross-sectional diagrammatic view of an alternative embodiment for the print head in a non-linear track; and

FIG. 4 is a progressive side view of the movement of the flood bar during the flood stroke and the squeegee during the print stroke of a print cycle.

### DETAILED DESCRIPTION OF THE INVENTION

Hereinafter, there will be described in detail an image printing apparatus to which the present invention is applied by reference to the drawings.

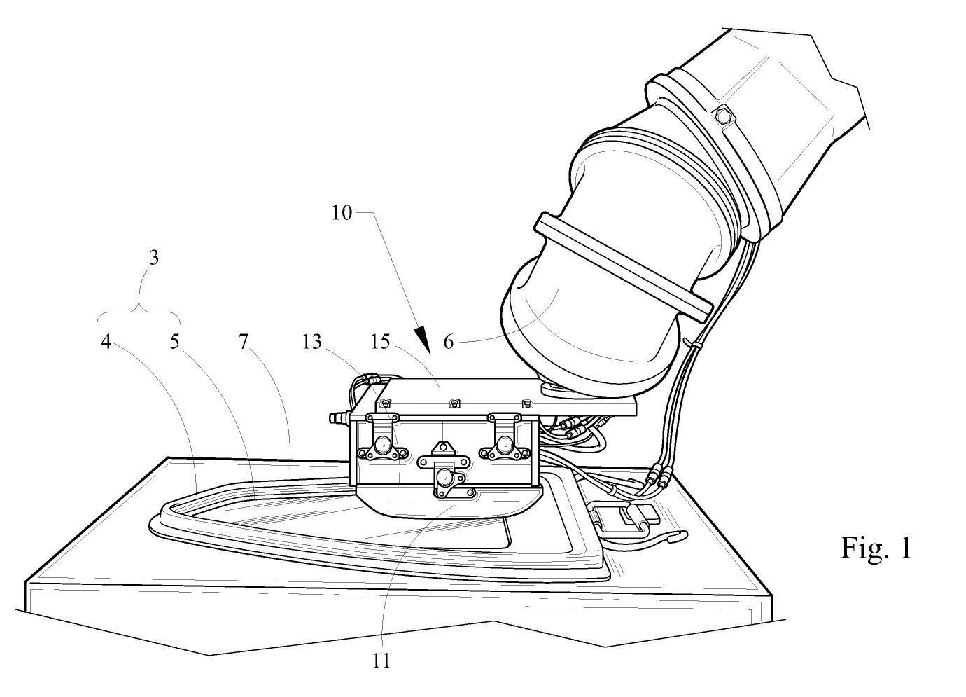

Referring now to FIG. 1, a printing system incorporating the printing apparatus of the present invention is shown. In this printing system, the printing apparatus 10 is attached to a robot arm 6 via a top plate 15. The movement of the robot arm 6 allows the printing apparatus 10 to come into close proximity with the surface of substrate 3 as it is held stationary by a fixture 7. This close proximity being referred to herein as a predetermined off-contact distance. As will be fully described in the following discussion, the printing apparatus 10 is capable of printing an image anywhere on the substrate's surface 5 even within close proximity to a substantial change in the curvature or step-height of the surface. Such a step-height change is shown for the illustrated substrate 3 as the interface between surfaces 4 and 5. Although the substrate 3 is shown to be an injection molded window having a transparent plastic surface 5 and an opaque plastic border 4, the present invention is equally applicable to printing an image on other substrates.

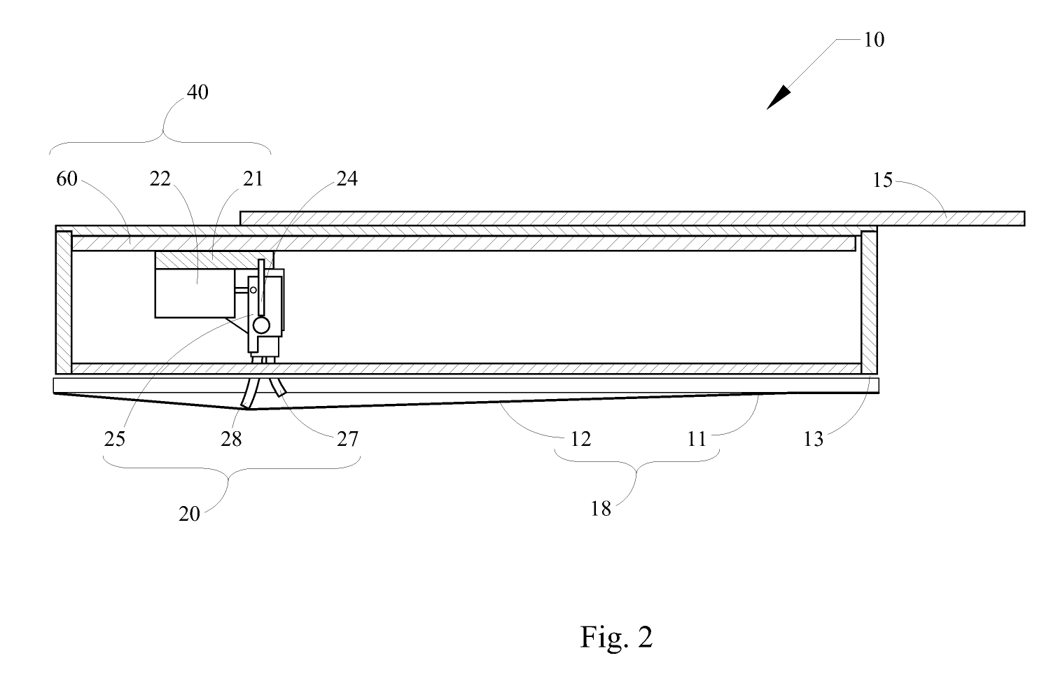

In FIG. 2 the printing apparatus 10 is shown to generally comprise a screen assembly 18, a squeegee assembly 20, and a guide assembly 40. The screen assembly 18 may include a screen 12 either embedded or secured to a screen frame 11. Preferably, the screen frame 11 is conformable to the curvature of the surface of the substrate upon which the image is to be printed. The screen frame is flexible in at least one direction. In a preferred embodiment, the screen 12 is a high tension, low elongation material capable of receiving and transferring a pigment containing material, such as printing ink. One example of a screen 12 material is a porous and flexible mesh of polyester or polyamide fibers, or a combination of both. Obviously, other materials known to someone skilled-in-the-art of screen printing, such as stainless steel, could alternatively be used. The screen frame 11 is constructed so as to enable tensioning of the screen 12, while at the same time providing a degree of flexibility to the screen 12. The screen frame 11 is mounted in a screen frame holder (not shown), which may be constructed of metal, such as but not limited to spring steel, as well as any other desired material. Additionally, the screen assembly 18 may optionally include a gasket 13 on to its top surface, as is shown in FIG. 1 and FIG. 2. This gasket 13 forms a seal between the screen assembly 18 and the frame in which the squeegee assembly 20 and guide assembly 40 are mounted.

In accordance with present invention, the squeegee assembly 20 includes a flood bar 27 to spread a printing medium, such as ink 1, onto the screen 12 during a flood stroke; a squeegee 28, to force the ink 1 through the screen 12 to form an image on the substrate 5 during the print stroke and a print head 25, which provides a holding means for both the flood bar 27 and the squeegee 28, and for positioning them at a predetermined angle. The flood bar 27 and squeegee 28 are further attached to the lower portion of the print head 25 to maintain a desired off-contact distance at which the squeegee 28 is held relative to the screen 12. The flood bar and the squeegee are constructed of a material commonly used by someone skilled-in-the-art of screen printing for the construction of squeegees, which include, among other materials, various rubbers and elastomers. In a preferred embodiment, the flood bar 27 and squeegee 28 are both made of a polyurethane material.

The guide assembly 40 comprises the means through which the squeegee assembly 20 is caused to interact with and move perpendicularly across the screen assembly 18. In one embodiment of the present invention, the guide assembly 40 comprises at least one guide rod 60 and at least one pneumatic actuator or air cylinder 22. The pneumatic actuator or air cylinder 22 may be mounted to the guide rod 60 by a carriage plate 21 with a pivot point 24 being projected downward from the carriage plate 21.

The air cylinder 22 may be any pneumatic actuator known in the art including those comprising a rod attached to a piston, as well as those defined as being rod-less, wherein magnets couple the cylinder's piston with a mobile carrier. However, a dual acting actuator is preferred due to the movement in opposite directions during the flood stroke and print stroke in the print cycle.

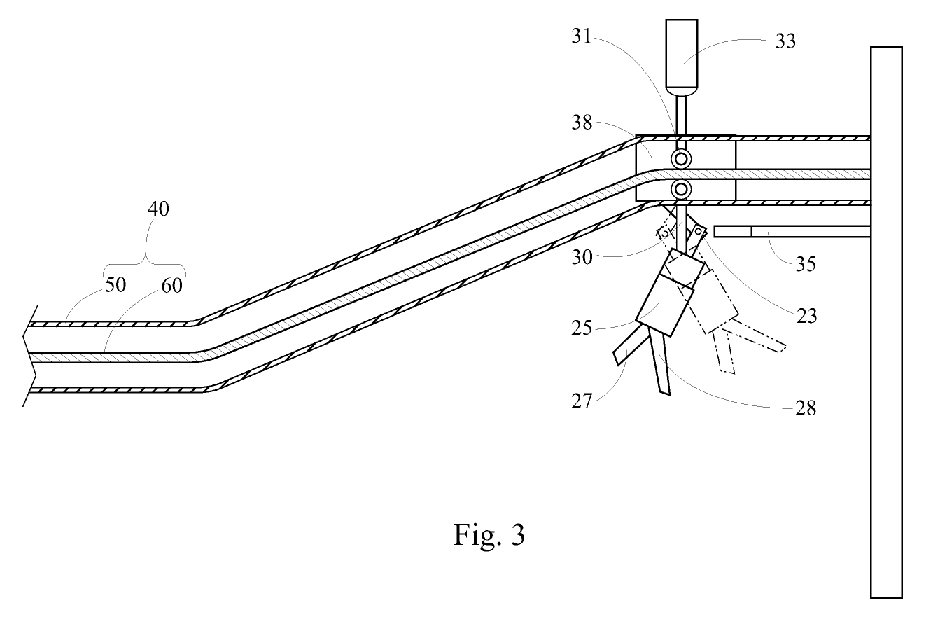

In another embodiment of the present invention, the guide assembly 40 may utilize in place of the air cylinder 22, at least one push rod 35 mounted on the side wall of the printing apparatus 10 and located generally perpendicular to the squeegee assembly 20, as shown in FIG. 3. Preferably, such a push rod 35 would be mounted on each side wall that represents the end of the print stroke and flood stroke in the print cycle. In this embodiment of the present invention, the printing apparatus 10 further comprises a supporting means through which the guide assembly 40 and the squeegee assembly 20 are attached. Such supporting means may be a threaded rod 30 and a squeegee adjustable knob 33, which are designed in such a way that they assist the vertical adjustment of the squeegee assembly 20 as desired by the shape of the screen assembly 18 with respect to the surface 5 of the substrate 3.

For either embodiment, during the horizontal movement of the printing apparatus 10 in the print cycle along the guide rod 60, the pneumatic actuator 22 or push rod 35 actuates a pivot mechanism in the print head 25 resulting in a pivoting movement, an upward and downward shifting of the squeegee 28 and flood bar 27, of the squeegee assembly 20. Preferably, the pivoting means is via the interaction of the pneumatic actuator 22 and the pivot point 24 projected downward from carrier plate 21 to the print head 25. When the push rod 35 is utilized instead of the pneumatic actuator 22, the pivoting means is in the form of a universal joint (U-joint) 23 or similar construction. In either embodiment of the present invention, the pivoting means allows for about a 30 degree back and forth movement of the squeegee 28 and flood bar 27 at either end of the guide rod 60 during the print cycle.

The guide rod 60 preferably comprises the cylinder body of a rod-less pneumatic actuator or a guide track to which the piston rod of the pneumatic actuator is attached. However, as shown in the embodiment of the present invention depicted in FIG. 3, the guide rod 60 may act as a guide track flanked by guide belts 50 on either side, along which a print head bar 38 makes a horizontal movement in a direction parallel to the screen frame 11. The print head bar 38 is connected to the guide rod or track 60 and guide belts 50, by an adjustable means, which is represented in FIG. 3 by a pair of guide wheels 31. One advantage represented by this embodiment of the present invention is that the guide rod and guide belts can be linear or curved, thereby, allowing the printing apparatus 10 to maintain a constant off-contact distance and be relatively parallel to the surface of a curved substrate.

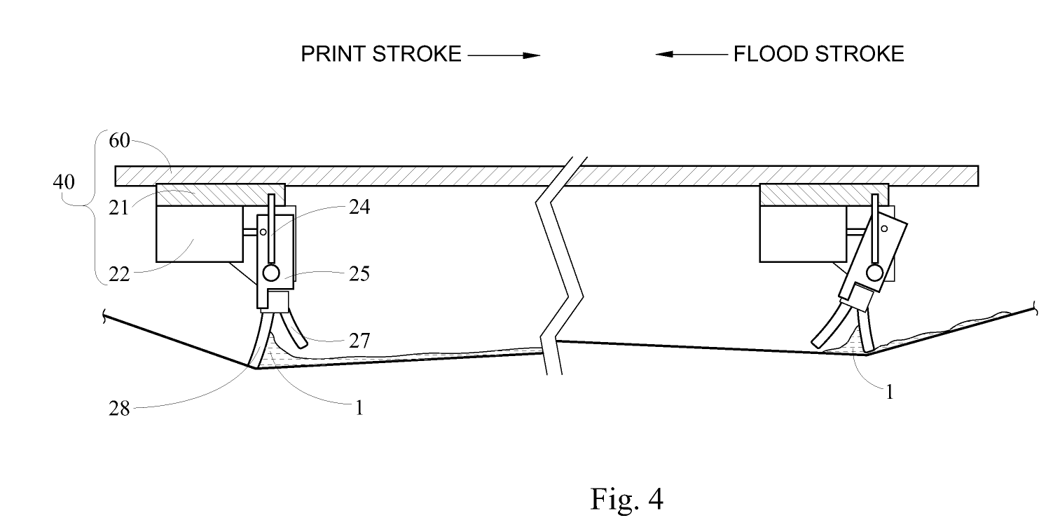

During a print cycle as depicted in FIG. 4, the reciprocating movement of the guide assembly 40 toggles the squeegee 28 and the flood bar 27 in the squeegee assembly 20 through a pivoting motion. As noted above, this pivoting motion is actuated or driven by the push rod 35 or air cylinder 22, which facilitates a downward presentment of the flood bar 27 against the screen 12 during a flood bar stroke and the squeegee 28 against the screen 12 during a print stroke. Similar to conventional screen printing, the flood bar stroke lightly spreads or floods the screen with a layer of ink 1, while the print stroke causes the ink 1 to be pushed through the screen, thereby, depositing the desired printed image on to the substrate.

The printing apparatus 10 of the present invention can be used to print images on a variety of substrates. Some of the more common substrates include fabrics, metals, glass, plastics, paper, composites, and paperboard. The substrate on which the images are printed may be planar, or may have different shapes and curvatures, as well as various design features, such as frames, lips, ribs, or a change in step height. A change in step height represents a transition between two areas on a substrate that are not in the same geometric plane. An example of such as step height is illustrated in FIG. 1 for substrate 3 as the interface between surface 4 and surface 5.

In a preferred embodiment, the substrate 3 is an injection molded automotive plastic window or panel. Such a substrate may be comprised of any thermoplastic or thermoset polymeric resin. Typically, a plastic window is substantially comprised of a transparent region 5, but may contain opaque regions 4, such as, but not limited to, an opaque frame or border. The polymeric resins may include, but are not limited to, polycarbonate, acrylic, polyarylate polyester, polysulfone, polyurethane, silicone, epoxy, polyamide, polyalkylenes, and acrylonitrile-butadiene-styrene (ABS), as well as copolymers, blends, and mixtures thereof. The preferred transparent, thermoplastic resins include, but are not limited to, polycarbonate, acrylic, polyarylate, polyester, and polysulfone, as well as copolymers and mixtures thereof.

The printing apparatus 10 of the present invention may be used to apply a printed image directly on to the surface of the substrate 3 or on to the surface of any coating or film that may be applied to the substrate 3. Such a coating or film may be present to protect the substrate against weathering, abrasion, or any other means of being damaged or degraded.

The substrate 3 is placed into a fixture 7 and held stationary during the print cycle. The substrate 3 may be held in the fixture by any mechanical or other means known to someone skilled in the art of printing. Examples of mechanical means for holding the substrate in place include, but are not limited to, clamps, hooks, pins, suction cups, and fasteners. A preferred method of holding the substrate in place during the print cycle is through the use of vacuum or negative pressure applied to the substrate opposite to the side upon which the printed image will be applied. Such negative pressure may be established by any means known to someone skilled in the art of printing, including but not limited to the use of an air venturi vacuum system. Suction cups may be utilized in conjunction with a vacuum system to provide additional support for holding the substrate.

The loading of the substrate 3 into a fixture 7 may be done manually, for example by an operator. Alternatively, the loading can be performed automatically by a transporting means such as a suitably programmed robot arm or other machine. A substrate may similarly be unloaded in the same manner as the loading of the substrate. For example, the substrate may, after it has been printed on, be removed from the printer either manually or automatically. In a preferred embodiment, the substrate includes articles of the automotive industry, such as an automotive glazing panel, wherein the substrate is moved by a robot in line with the cycle time established by the injection molding of the substrate, where printing can take place after molding and before coating or storage.

Similarly, a suitably programmed robot arm 6 may transport the printing assembly 10 to the substrate 3 held in a fixture 7. The robot arm 6 may manipulate the position of the printer in relation to the substrate in order to establish an appropriate off-contact distance necessary to apply a printed image with great clarity. The robot arm may further manipulate the position of the printer to apply multiple printed images on to the substrate. In an adaptation to this embodiment, the fixed substrate may be moved along by a conveyor belt, while the robot, in its “line tracking” mode, keeps the printing apparatus in a constant position relative to the fixed substrate. Although not shown, another embodiment of the present invention is to maintain the printing apparatus in a stationary position and allow the substrate to be held in a fixture that can be robotically manipulated or moved during a print cycle.

The nature of the printed image applied to the substrate 3 by the printing apparatus 10 depends upon that desired pattern. Examples, of such patterns include but are not limited to logos, script, pictures, trademarks, and fractal antennas, as well as borders or frames comprised of lines, dots, or other geometric images.

Preferably, the printing apparatus 10 further comprises at least one means (not shown) for locating and delivering the printing ink 1 adjacent to the screen 12. The ink 1 should be delivered in a pre-determined quantity to the surface of the screen 12 near the squeegee assembly 20 at a predetermined time before the screen 12 is initially deformed to initiate the flood bar stroke. The flood bar 27 evenly distributes or spreads the printing ink 1 across the upper surface of the screen 12 during the flood bar stroke. Then during the print stroke, the printing ink 1 is forced through the screen 12 by the squeegee 28 to form an image on the surface 5 of the substrate 3.

The printing apparatus 10 of the present invention provides many advantages over conventional screen printing. For example, when a printed image is applied to substrate 3 while the substrate is at an elevated surface temperature, conventional screen printing is severely hampered by accelerated evaporation of the solvent in the ink resulting in the drying of the ink in the screen. An elevated surface temperature of the substrate 3 would occur if the printing was performed immediately after the injection molding of the substrate. The printing apparatus 10 of the present invention overcomes this issue by enclosing the area above the screen 12 via the presence of a top plate 15. This top plate serves as a “lid” on top of the printer, which inherently trap the solvent present in the ink 1 inside the printing apparatus. The saturation of the air volume within the printing apparatus 10 with a solvent-rich mixture assists in reducing the possibility that the ink 1 could dry in the screen.

In addition to the above advantage, the printing apparatus 10 of the present invention represents a printer that is significantly smaller in size than a conventional screen printer. The printing apparatus 10 is especially suitable for printing small features with image sizes typically in the range of about 5×10 mm to about 50×150 mm in dimension.

The process for printing an image on a substrate 3 using the printing apparatus 10 of the present invention may further be elaborated upon as described below. In general, the printing apparatus 10 comprises a guide assembly 40 whose movement is along the guide rod 60 in a generally horizontal direction, and a squeegee assembly 20 which provides the necessary downward pressure on the screen 12. The basic printing mechanism of the printing apparatus 10 comprises placing the substrate 3 in a position with respect to the screen frame 11 and screen assembly 18, engaging the flood bar 27 with the printing ink on the print screen 12, moving the flood bar 27 along the screen 12 to distribute the ink, lowering the screen 12 to a predetermined off contact distance from the surface of the substrate 3 such that the screen 12 conforms to the shape of the substrate 3, moving the squeegee 28 along the screen 12 to impart ink to the substrate 3, and raising the print screen 12 to remove the substrate 3 after being printed with the desired image.

During the printing process according to the present invention, the screen frame 11 comprises the inverse of the image pattern that is to be printed on the substrate. The screen frame 11 conforms to the shape of the substrate by a tensioning mechanism operated by the screen assembly 18, when the printer and substrate are brought in contact with each other. The substrate 3 on which the image is printed is held in position by a separate fixture 7.

The print cycle, in general, comprises a flood stroke and a print stroke, which involves the movement of the print head 10 along the guide rod 60. During the flood stroke, the flood bar 27 is swept over the surface of the screen 12 in a direction along the substrate 3 on which the image is printed, thereby engaging the screen assembly 18 to evenly distribute the printing ink 1 as illustrated in FIG. 4. This is followed by a print stroke, wherein the squeegee 28, is drawn across the screen 12 to effect printing on the substrate 3 also shown in FIG. 4. As the guide assembly 40 moves horizontally along the guide rod 60, the pneumatic actuator 22 or push rod 35 located on the side of the printer actuates the pivoting motion of the squeegee assembly, switching the flood bar and squeegee for presentment against the screen 12. After printing, the squeegee 28 is raised from the screen frame 11 and the printed object is removed either manually or by a robotic means.

It is to be understood that the present invention may be embodied with other changes, modifications, variations, and improvements, such as those described in the above description, which may occur to a person skilled in the art, without departing from the spirit and scope of the invention defined by the appended claims.

We claim:

1. An image printing apparatus for printing designs and images onto a substrate, the apparatus comprising:
a screen assembly including a screen, a screen frame, and a screen frame holder, said screen assembly being conformable to the surface of the substrate;
a print head, said print head being movable during a print cycle in a direction parallel to the screen assembly, said print head having a flood bar and a squeegee mounted thereto for common movement therewith; and
a guide assembly coupled to said print head and causing reciprocating movement of said print heat, said reciprocating movement including a switching of position of said flood bar and said squeegee for presentment thereof against said screen.

2. The apparatus of claim 1 wherein said screen frame is flexible in at least one direction.

3. The apparatus of claim 1 wherein said guide assembly comprises a guide rod and a actuator.

4. The apparatus of claim 1 wherein said actuator drives a pivot mechanism in said print head, said pivot mechanism adapted to cause the switching of position of said flood bar and said squeegee.

5. The apparatus of claim 4 wherein said pivot mechanism is adapted to cause an upward and downward switching of position of said flood bar and said squeegee.

6. The apparatus of claim 1 wherein said actuator is a rod-less dual action air cylinder.

7. The apparatus of claim 1 wherein said guide rod is the air cylinder of the pneumatic actuator.

8. The apparatus of claim 1 wherein said guide assembly includes a guide track and a guide belt connected to said print head, the guide assembly also including a push rod, said push rod cooperatively engaging a pivot mechanism in the print head to cause said switching of position of said flood bar and said squeegee.

9. The apparatus of claim 8 wherein said guide track and said guide belt are non-linear.

10. The apparatus of claim 1 wherein said print apparatus further includes a housing cooperating with said screen assembly to substantially enclose said print head and said guide assembly thereby minimizing solvent evaporation.

11. The apparatus of claim 10 wherein said housing includes a top plate and side walls.

12. The apparatus of claim 11 wherein said top plate is attached to an articulating arm of a robot, said robot being programmable for manipulation of the printing apparatus to position the screen assembly at a predetermined off-contact distance from the substrate.

13. The apparatus of claim 1 wherein said screen defines a maximum printing area of about 50×150 mm.

14. A method of printing designs or images on a substrate utilizing a printing apparatus having a screen assembly, a print head with a flood bar and a squeegee, and a guide assembly, said method comprising the steps of:
placing a substrate in a fixture;
manipulating one of the fixture and the printing apparatus to position the screen assembly at a predetermined off-contact distance with respect to the substrate;
placing a printing ink onto a print screen of the screen assembly;
moving the print head across the screen whereby the flood bar distributes the ink across the screen;
pivoting said print head such that the squeegee switches position with the flood bar and is presented to the screen;
drawing said print head across the screen whereby said squeegee imparts the ink through the screen and onto the substrate to form the design or image thereon;
moving the printing apparatus and the substrate away from one another after forming of the design or image thereon; and
removing the substrate from the fixture.

15. The method according to claim 14, wherein the pivoting step is actuated by a push rod.

16. The method according to claim 14, wherein the pivoting step is actuated by an air cylinder.

17. The method according to claim 14 wherein the design or image has a size between about 5×10 mm to about 50×150 mm.

18. The method according to claim 14 wherein the printing apparatus is stationary and the fixture is robotically moved relative thereto.

19. The method according to claim 14 wherein the fixture is stationary and the printing apparatus is robotically moved relative thereto.

20. The method of claim 14 wherein the manipulating step moves the fixture by a conveyor belt while the printing apparatus is held in a fixed position relative to the substrate by a robot that is tracking the substrate on the conveyor belt.
